(19) United States
(12) Patent Application Publication
(10) Pub. No.: US 2017/0343044 A1
(43) Pub. Date: Nov. 30, 2017

(54) GREEN COMPACT AND METHOD FOR PRODUCING SAME

(71) Applicant: NTN CORPORATION, Osaka (JP)

(72) Inventors: Naoki YASHIRO, Mie (JP); Kouya OOHIRA, Mie (JP)

(73) Assignee: NTN CORPORATION, Osaka (JP)

(21) Appl. No.: 15/533,716

(22) PCT Filed: Nov. 20, 2015
(86) PCT No.: PCT/JP2015/082711

§ 371 Date: Jun. 7, 2017

(30) Foreign Application Priority Data
Dec. 19, 2014 (JP) 2014-257337

(51) Int. Cl. F16C 33/14; B22F 3/02; F16C 33/10; B22F 3/24; F16C 33/12

(52) U.S. Cl. CPC F16C 33/145; B22F 3/24; F16C 33/128; F16C 33/1025; B22F 3/02; B22F 2003/242; F16C 2220/20; B22F 2301/35

(57) ABSTRACT

A green compact according to the present invention is a green compact, which is obtained by compaction-molding raw material powder containing metal powder as a main raw material, the green compact including an oxide film formed between particles of the raw material powder forming the green compact, the oxide film binding the particles of the raw material powder to each other, in which the metal powder to toe used includes metal powder showing a circularity R at a cumulative frequency of 80% of 0.75 or more, the circularity R being expressed by Equation (1), where S represents a two-dimensional projected area of the metal powder and L represents a two-dimensional projected circumferential length of the metal powder.

$$R = 4 π \times \frac{S}{{L}^{2}} \qquad ( 1 )$$

### TECHNICAL FIELD

The present invention relates to a green compact and a method of producing the green compact, and more particularly, to a green compact suitable as a material for a machine part to be used by being impregnated with a lubricating oil, for example, a sliding part and a method of producing the green compact.

### BACKGROUND ART

In the field of powder metallurgy, a product has hitherto been generally obtained by mixing raw material powders each including metal powder as a main raw material, and compaction-molding the mixed powders, followed by sintering in a furnace at a high temperature of more than 800° C. However, the cost of this step accounts for from ¼ to ½ of the entire production cost. In addition, a green compact expands or shrinks through the sintering step at high temperature, and hence a correction (so-called sizing) step after sintering is indispensable in order to keep the dimensions and accuracy of the product within target dimensions and target accuracy. For the above-mentioned reasons, even when a powder metallurgical technology that is supposed to be capable of low-cost production is used, an expected cost reduction may not be achieved.

Accordingly, hitherto, there has been proposed a method of increasing strength of a green compact based on a technique other than sintering.

That is, in Patent Literature 1, there is a disclosure that an iron-based “sintered” part is produced by binding a green compact through steam treatment without perforating sintering. Specifically, there is a disclosure of a method involving covering the entire surface of the green compact with an oxide film through the steam treatment, to thereby bind particles forming the green compact to each other, resulting in an object having predetermined Strength as a whole (lines 8 to 11 in the lower left column on page 2 of Patent Literature 1).

### CITATION LIST

Patent Literature 1: JP 63-072803 A

### SUMMARY OF INVENTION

### Technical Problem

However, in Patent Literature 1, there is only a disclosure “having some degrees of strength and durability” (lines 7 and 8 in the upper right column on page 2), and there is no disclosure of what degree of strength is actually obtained. In fact, there is a disclosure “some applications of magnetic material parts do not require very high strength, and an inexpensive part that is easy to produce for such applications is provided” (lines 10 to 12 in the upper left column on page 2), and a soft magnetic material part is given as a specific example. In view of this, it is conjectured that the range of applications of the green compact disclosed in Patent Literature 1 is limited, to parts (technical fields) that are not required to have high strength. It is difficult to apply the green compact disclosed in Patent Literature 1 to a machine part required to have high strength, for example, a sliding part.

In addition, details of the material and density of the green compact, the conditions of steam treatment, and the like, which are considered to be important in increasing the strength of the green compact, are not disclosed anywhere in Patent Literature 1, and hence there is -found no measure for increasing the strength of a green compact utilizing an oxide film for binding between particles of powder.

In particular, when the above-mentioned green compact is used for a sliding part, for example, a slide bearing, not only its strength, but also the oil-impregnated rate of the green compact needs to foe taken into consideration. The green compact is obtained toy compaction-molding raw material powder, for example, metal powder. Accordingly, the green compact has a large number of internal pores, and has a structure in which the pores communicate to each other. Accordingly, as the volume ratio of the pores communicating to each other in the green compact increases, the oil-impregnated rate also increases. Meanwhile, in order to increase the strength of the green compact, it is necessary that the density of the green compact, i.e., green density (referring to the density of the green compact calculated on the assumption that there is no pore inside the green compact. The same applies hereinafter.) be increased. However, for the above-mentioned reason, there is a problem in that as the green density increases, the ratio of the internal pores in the green compact (hereinafter referred to simply as “porosity”) decreases.

In view of the above-mentioned circumstances, a technical object to foe achieved by the present invention is to provide a green compact capable of exhibiting strength comparable to that of a related-art sintered part, and capable of showing an oil-impregnated rate sufficient for use as a sliding part, at low cost.

### Solution to Problem

The above-mentioned object can be achieved with a green compact according to a first aspect of the present invention. That is, the green compact is a green compact, which is obtained by compaction-molding raw material powder containing metal powder as a main raw material, the green compact comprising an oxide film formed between particles of the raw material powder forming the green compact, the oxide film binding the particles of the raw material powder to each other, wherein the metal powder to be used comprises metal powder showing a circularity E at a cumulative frequency of 80% of 0.75 or more, the circularity R being expressed by Equation 1, where S represents a two-dimensional projected area of the metal powder and L represents a two-dimensional projected circumferential length of the metal powder.

$$R = 4 π \times \frac{S}{{L}^{2}} \qquad Equation 1$$

The above-mentioned object can also fee achieved with a green compact according to a second aspect of the present invention. That is, the green compact is a green compact, which is obtained by compaction-molding raw material powder containing metal powder as a main raw material, the green compact comprising an oxide film formed between particles of the raw material powder forming the green compact, the oxide film binding the particles of the raw material powder to each other, wherein the metal powder to be used comprises metal powder showing a jaggedness C at a cumulative frequency of 80% of leas than 2.90, the jaggedness C being expressed by Equation 2.

$$C = \frac{1}{4 π} \times \frac{{L}^{2}}{S} \qquad Equation 2$$

For example, iron-based powder is generally used as metal powder for forming a sintered, part, for example, a slide bearing. More specifically, in ordinary cases, reduced iron powder is often adopted as the iron-bases powder from the viewpoints of moldability and material cost. However, as compared to gas atomized powder, water atomized powder, or the like, the reduced iron powder is inferior in surface smoothness, and often has a distorted shape having rather large surface jaggedness. In a general sintering step, the jaggedness exhibits an action of increasing the number of points of contact between particles of the powder, and hence increases a necking amount to increase the strength of the green compact. However, when a mode in which particles of the raw material powder forming the green compact are bound to each other by forming an oxide film on the surface of the metal powder through steam treatment or the like is investigated, a green compact formed of the reduced iron powder has an extremely complex and distorted inner surface structure, and the oxide film (in this case, an iron oxide film) is formed on the inner surface. Accordingly, minute pores, or a space linking adjacent pores to each other (sometimes referred to as “communicating path”. The same applies hereinafter.) may be blocked. With this, the porosity lowers, and there is a concern that an actual oil-impregnated rate may fall short of the porosity.

The present invention has been made on the basis of the above-mentioned findings and discussion, and has a feature in using, as metal powder to be used for raw material powder of a green compact, metal powder having a shape close to a sphere or having a smooth surface as compared to metal powder that has been used for a related-art sintered part. Specifically, the present invention has a feature in using metal powder showing a circularity R expressed by Equation 1 of 0.75 or more, or using metal powder shoeing a jaggedness G expressed toy Equation 2 of less than 2.90. According to the green compact according to this configuration, as demonstrated in experimental results to be described later, it has been revealed that, without lowering the green density much, predetermined strength, for example, strength of a level required of a sliding part can be obtained, and a predetermined oil-impregnated rate, for example, an oil-impregnated rate of a level required of a sliding part can be achieved. In other words, the adjustment of the green density to an appropriate range can increase both the strength and oil-impregnated rate of the green compact. One possible reason therefore is as follows: as compared to the related art, the shape of the metal powder to be used is closer to a spherical shape or has a smoother surface, and hence the green compact formed of such metal powder has a relatively simple internal structure. That is, when the green compact has a simple internal structure, the ratio of fine pores decreases and the ratio at which the communicating paths linking the pores to each other have minute sizes reduces. It is conjectured that, with this, the ratio at which the pores or the communicating paths are blocked by the oxide film is reduced as much as possible, and as a result, the oil-impregnated rate increases.

Thus, through the use of the green compact according to the present invention, a machine part, for example, a sliding part that can achieve a satisfactory oil-impregnated rate as well as the strength of the above-mentioned level can be produced. Accordingly, it is possible to suppress lubrication failure, for example, seizure, while preventing breakage due to continuous use, to thereby use the part in a satisfactory manner over a long period of time. In addition, metal powder having an appropriate shape only needs to be selected by using the circularity R or the jaggedness C as a criterion, and hence a lubricant or other powders to be blended into the raw material powder as necessary, and various production facilities, such as a molding facility, a facility for forming the oxide film, and an oil-impregnating facility, which are similar to those of the related art, can be used. Accordingly, an increase in production cost can be avoided. Heedless to say, the covering of the surface of the green compact with the oxide film obviates the need for anti-rust treatment, and hence the cost can be reduced all the more for that. Herein, the “strength of a level required of a sliding part” refers not to strength of a level required for improving the chipping resistance of the green compact or required of a soft magnetic material part, but to such a level as to allow use as a sliding part, for example, a sintered oil-impregnated bearing, specifically a radial crushing strength measured and evaluated in conformity to JIS Z 2507 of 100 MPa or more. In addition, the “oil-impregnated rate of a level required of a sliding part” refers to such a level that a lubricating oil retained in internal pores of the green compact continuously seeps out onto its sliding surface in an appropriate amount, specifically 12 vol % or more.

In addition, in the green compact according to the present invention, when the metal powder shows a circularity R at a cumulative frequency of 80% of 0.75 or more, the metal powder to be used may further show a jaggedness C at a cumulative frequency of 80% of less than 2.90. Alternatively, when the metal powder shows a jaggedness C at a cumulative frequency of 80% of less than 2.90, the metal powder may further show a circularity R at a cumulative frequency of 80% of 0.75 or more. In this case, the jaggedness C is expressed by Equation 2 above, and the circularity R is expressed by Equation 1 above.

When the metal powder is selected on the basis of the circularity R and the jaggedness C as described above, metal powder suited for a non-sintered green compact can be adopted more appropriately. Accordingly, reliability can be improved, and by extension, a variation in quality can be decreased to provide a sliding part of stable quality.

In addition, the green compact according to the present invention may show a green density of 5.0 g/cm³ or more and 7.6 g/cm³ or less, preferably 5.3 g/cm³ or more and 7.2 g/cm³ or less, more preferably 6.0 g/cm³ or more and 7.0 g/cm³ or less.

From the viewpoint of adhesiveness between particles of powder, as the green density increases, the strength of the green compact increases. However, when the green density is excessively high (e.g., more than 7.6 g/cm³), a treatment medium (e.g., steam) for forming the oxide film cannot penetrate an inside of the green compact, and the formation of the oxide film is limited to only a surface layer of the green compact. Accordingly, a sufficient increase in strength is difficult to achieve. Meanwhile, when the green density is excessively low (e.g., less than 5.0 g/cm³), the adhesiveness between the particles of the powder lowers, and moreover, a distance between the particles of the powder increases, with the result that it is difficult to form the oxide film across the particles of the powder. For the above-mentioned reasons, when the green density of the green compact is adjusted to the above-mentioned range, a green compact achieving both the strength and the oil-impregnated rate of levels required of a sliding part can be obtained.

In addition, in the green compact according to the present invention, the metal powder forming the green compact may be iron-based powder.

For the iron-based powder, established powder production methods are available, the methods being based on, for example, an atomizing method using gas, water, centrifugal force, plasma, or the like, a melt spinning method, a rotating electrode method, a pulverization method (mechanical alloying method), and a chemical treatment method using oxidation-reduction, chlorination-reduction, or the like, and its shape is easy to adjust as well. Accordingly, iron-based powder having the shape according to the present invention can be obtained stably and inexpensively, and a green compact of stable quality can be provided at low cost.

In addition, in the green compact according to the present invention, the oxide film may be formed by subjecting a surface of the raw material powder to steam treatment.

In a related-art sintering step, a green compact is heated to a high temperature equal to or lower than a melting point (from about 800 ° C. to about 1,300° C. when the iron-based powder is used as the main raw material) to form necking between particles of the powder, to thereby achieve an increase in strength. In contrast, according to the steam treatment according to the present invention, the green compact is allowed to react with steam having a relatively low temperature (from about 400° C. to about 700° C, when the iron-based powder is used as the main raw material) in an oxidizing atmosphere to form the oxide film between particles of the metal powder, and the oxide film can bind the particles of the powder to each other. When, as just described, the heat treatment temperature is low as compared to that in the sintering step, a dimensional change after the heat treatment (steam treatment) can toe decreased (a dimensional change rate before and after the treatment is ±0.1% or less). Accordingly, a sizing step, which has heretofore been necessary for correcting dimensions after sintering, can be eliminated or simplified (the number of times of sizing can be reduced), and hence a product and a mold for compaction-molding can be easily designed. Further, (electric or heat) energy required for the treatment can be reduced by virtue of the low treatment temperature. Besides, the number of treatment steps can toe reduced, and the production process of one product can be shortened and the cost of the product can be further reduced.

The green compact described above can be suitably used in, for example, a slide bearing, which is formed of the green compact, the slide bearing comprising a bearing surface configured to slidably support a shaft.

In addition, in this case, in the slide bearing according to the present invention, internal pores of the green compact may be impregnated with 12 vol % or more of a lubricating oil, preferably impregnated, with 15 vol % or more of a lubricating oil.

In addition, the above-mentioned object can also be achieved with a method of producing a green compact according to the first aspect of the present invention. That is, the production method is a method of producing a green compact obtained by compaction-molding raw material powder containing metal powder as a main raw material, the green compact comprising an oxide film formed between particles of the raw material powder forming the green compact, the oxide film binding the particles of the raw material powder to each other, the method comprising the steps of: molding the green, compact using, as the metal powder, metal powder showing a circularity R at a cumulative frequency of 80% of 0.75 or more; and subjecting a surface of the raw material powder in a state of forming the green compact to steam treatment, to thereby form the oxide film between the particles of the raw material powder, the circularity R being expressed by Equation 1, where S represents a two-dimensional projected area of the metal powder and L represents a two-dimensional projected circumferential length of the metal powder.

In addition, the above-mentioned object can also be achieved with a method of producing a green compact according to the second aspect of the present invention. That is, the production method is a method of producing a green compact obtained by compaction-molding raw material powder containing metal powder as a main raw material, the green compact comprising an oxide film formed between particles of the raw material powder forming the green compact, the oxide film binding the particles of the raw material powder to each other, the method comprising the steps of: melding the green compact using, as the metal powder, metal powder showing a jaggedness C at a cumulative frequency of 80% of less than 2.90; and subjecting a surface of the raw material powder in a state of forming the green compact to steam treatment, to thereby form the oxide film between the particles of the raw material powder, the jaggedness C being expressed by Equation 2, where S represents a two-dimensional projected area of the metal powder and L represents a two-dimensional projected circumferential length of the metal powder.

In addition, in this case, in the method of producing a green compact according to the present invention, the steam treatment for the surface of the raw material powder may be performed in a temperature range of 400° C. or more and 700° C. or less.

### Advantageous Effects of Invention

As described above, according to the present invention, the green compact capable of exhibiting strength comparable to that of a related-art sintered part, and capable of showing an oil-impregnated rate sufficient for use as a sliding part can be provided at low cost.

### BRIEF DESCRIPTION OF DRAWINGS

FIG. 1A is an SEM image of pure iron powder according to Example 1 of the present invention produced by a water atomizing method.

FIG. 1B is an SEM image of pure iron powder according to Example 2 of the present invention produced by the water atomizing method.

FIG. 2A is an SEM image of pure iron powder according to Comparative Example 1 of the present invention produced by the water atomizing method.

FIG. 2B is an SEM image of pure iron powder according to Comparative Example 2 of the present invention produced by a reduction method.

FIG. 3A is an SEM image of pure iron powder according to Comparative Example 3 of the present invention produced by the reduction method.

FIG. 3B is an SEM image of pure iron powder according to Comparative Example 4 of the present invention produced by the reduction method.

FIG. 4 is a graph for showing the cumulative frequency distribution of the circularity R of the pure iron powder according to each of Example 1 and Comparative Example 4.

FIG. 5 is a graph for showing the cumulative frequency distribution of the jaggedness C of the pure iron powder according to each of Example 1 and Comparative Example 4.

### DESCRIPTION OF EMBODIMENTS

Now, one embodiment of the present invention is described by way of specific Examples.

First, test pieces according to Examples 1 and 2, and Comparative Examples 1 to 4 were produced using, as base material metal powder serving as a main raw material for raw material powder, six kinds of pure iron powders having shapes different from each other. Here, in each of Examples 1 and 2, and Comparative Example 1, pure iron powder produced by a water atomizing method was used, and in each of Comparative Examples 2 to 4, pure iron powder produced by a reduction method was used. For each kind of powder, only powder having a sieved particle size of 250 μm or less was used.

### (Production Procedure for Test Pieces)

Each kind of pure iron powder described above was blended and mixed with 0.7 wt % of a lubricant, in this case, an amide wax-based lubricant, and the mixture was loaded into a molding mold (alloy tool steel SKD 11) and subjected to uniaxial pressing at a predetermined molding pressure to provide a cylindrical green compact having a green density of 6.0±0.1 g/cm³. After that, the green compact was subjected to degreasing treatment at 350° C. for 90 minutes to remove a lubricant component in the green compact, and then subjected to steam treatment at 500° C. for 40 minutes. Thus, a cylindrical test piece was obtained. Dimensions in each case were set to inner diameter φ6 mm×outer diameter φ12 mm×axial-direction dimension 7 mm.

### (Evaluation of Shapes of Various Pure Iron Powders)

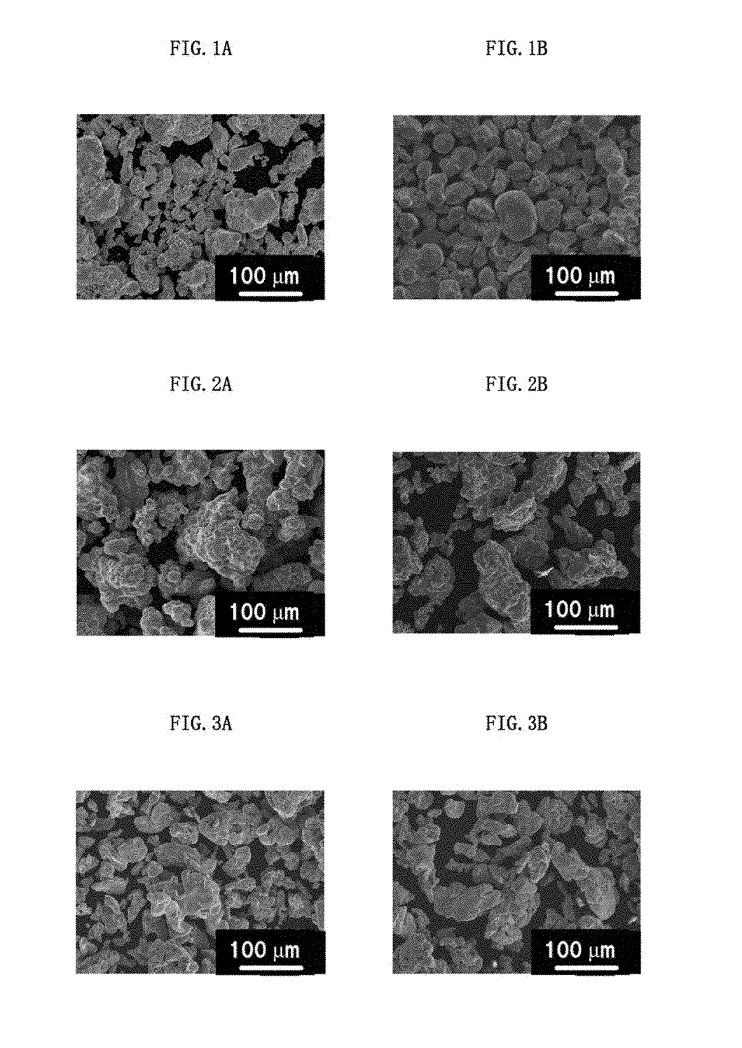

Now, in order to evaluate differences in various characteristics resulting from a difference in shape of pure iron powder serving as base material metal powder, differences between the shapes of various pure iron powders were expressed in numerical values by the following method. That is, various pure iron powders having the shapes shown in FIG. 1A, FIG. 1B, FIG. 2A, FIG. 2B, FIG. 3A, and FIG. 3B are each embedded in a resin, and then subjected to mirror polishing with sandpaper and buff to prepare a sample. At this stage, the polished surface of each sample is in a state in which a cross-section of each of the various pure iron powders is exposed.

Next, an image obtained by observing the polished surface of each sample with an optical microscope was subjected to binarization processing with predetermined image processing software (Mitani Corporation, WinROOF), and then the area and the circumferential length of the cross-section of each of the various pure iron powders (the area and the circumferential length in this case correspond to the two-dimensional projected area S and the two-dimensional projected circumferential length L of the metal powder, respectively) were measured for each particle to calculate the circularity R and the jaggedness C of each of the various pure iron powders for each particle. In this operation, measurement was performed for at least 4,000 particles of each kind of pure iron powder. When holes, such as pores, were present inside the cross-section of the pure iron powder, the area and the circumferential length of the cross-section were measured on the assumption that the holes were not present.

Then, on the basis of the area and the circumferential length obtained by performing measurement as described above (the two-dimensional projected area S and the two-dimensional projected circumferential length L), and Equation 1 and Equation 2, the circularity R and the jaggedness C of each of the various pure iron powders were calculated for each particle. Incidentally, as the circularity R gets closer to 1, the shape gets closer to a perfect circle (perfect sphere). In addition, as the jaggedness C gets closer to 1, the shape gets closer to a perfect circle (perfect sphere), or as the jaggedness C gets further away from 1, the contour shape is distorted, or the shape may be regarded as an elongated shape as a whole. As apparent from Equation 1 and Equation 2, the circularity R and the jaggedness C have a relationship of being the reciprocal of each other.

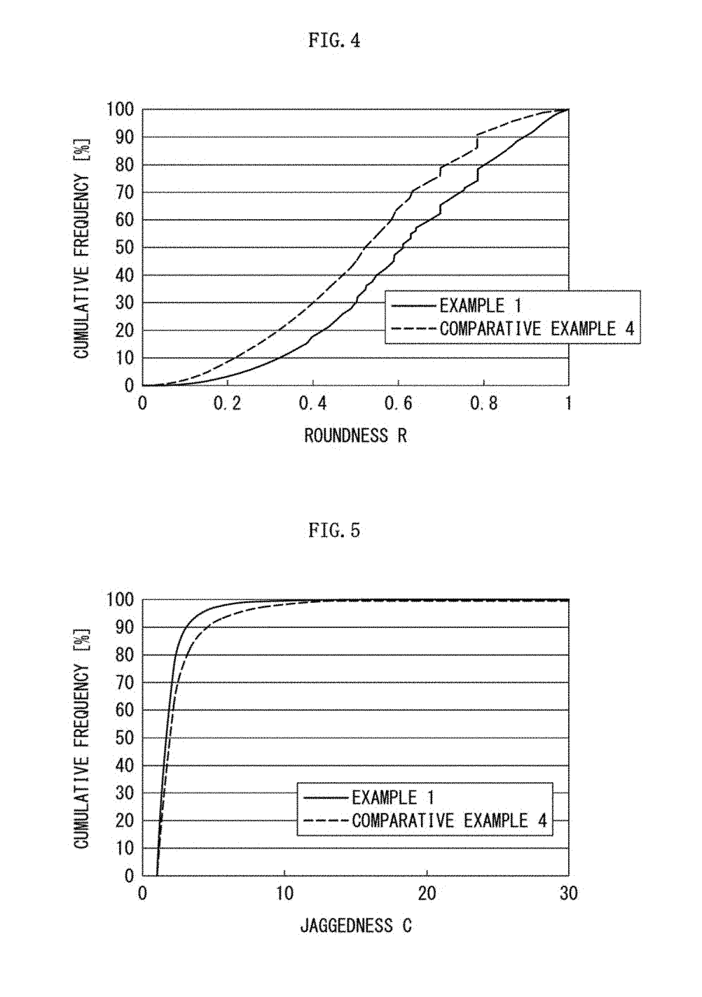

After the circularity R and the jaggedness C of each of the predetermined number (4,000 or more for each kind) of particles of pure iron powder had been thus calculated, the circularities R and the jaggednesses C were each arranged in ascending order to create a cumulative frequency distribution, and the circularity R and the jaggedness C at a cumulative frequency of 80%, at which differences among those shapes were considered to be most likely reflected in numerical values, were defined as the typical circularity R and jaggedness C of each of the various pure iron powders. As an example, the cumulative frequency distribution of the circularity R of each of Example 1 and Comparative Example 4 is shown in FIG. 4, and the cumulative frequency distribution of the jaggedness C thereof is shown in FIG. 5. In addition, the circularity R and the jaggedness C of each of Examples and Comparative Examples determined by the above-mentioned method are shown in Table 1.

TABLE 1

| | Production | | |
|---|---|---|---|
| | method | Circularity R | Jaggedness C |
| Example 1 | Water atomizing | 0.8 | 2.4 |
| | method | | |
| Example 2 | Water atomizing | 0.75 | 2.51 |
| | method | | |
| Comparative | Water atomizing | 0.74 | 2.9 |
| Example 1 | method | | |
| Comparative | Reduction method | 0.72 | 2.96 |
| Example 2 | | | |
| Comparative | Reduction method | 0.72 | 3.41 |
| Example 3 | | | |
| Comparative | Reduction method | 0.71 | 3.12 |
| Example 4 | | | |

### Evaluation of Radial Crushing Strength

The strength of the resultant test piece was evaluated on the basis of the result of measurement of radial crushing strength performed in conformity to JIS Z 2507. A testing device used in this case is Autograph AG-5000A manufactured by Shimadzu Corporation. Herein, the “radial crushing strength” refers to the strength of a cylindrical green Compact determined on the basis of a radial crushing load by a certain method, and the “radial crushing load” refers to a load .at which the cylindrical green compact, starts to break when compressed between two planes each parallel to its axis.

In this test, judgment criteria for the radial crushing strength were defined as described below. That is, the radial crushing strength (unit: MPa) is classified into three levels, i.e., 100 or more and less than 130, 130 or more and less than 150, and 150 or more, and respective corresponding evaluations are represented by Symbols “Δ”, “∘”, and “⊚” in order starting from the lowest value.

### (Evaluation of Oil-Impregnated Rate)

In addition, the oil-impregnated rate -of a test piece was evaluated on the basis of the result of measurement of an oil-impregnated rate performed in conformity to JIS Z 2501. The procedure and method therefore are as described below. First, the weight W1 (unit: g) of the test piece (green compact) before being impregnated with a lubricating oil (hydraulic action oil Shell Tellus S2 M 68, corresponding to ISO viscosity VG 68) is measured. Then, the test piece is immersed in the lubricating oil, and kept in a vacuumed state at 70° C. for 1 hour or more, and then the weight W2 (unit: g) of the test piece (green compact) after being impregnated with the lubricating oil is measured. After the weights of the test piece before and after impregnation had been thus measured, an oil-impregnated rate Oc (unit: vol %) was calculated on the basis of the following Equation 3. In Equation 3, V represents the volume of the green compact (unit: cm³), and ρ represents the density of the lubricating oil (unit: g/cm³).

$$Oc = \frac{W 2 - W 1}{ρ \times V} \times 100$$

In this test, judgment criteria for the oil-impregnated rate were defined as described below. That is, the oil-impregnated rate (unit: vol %) is classified into three levels, i.e., less than 12, 12 or more and less than 15, and 15 or more, and respective corresponding evaluations are represented by Symbols “x”, “∘” , and “⊚” in order starting from the lowest value.

Next, the evaluation results are described on the basis of Table 2. Herein, a test piece having a radial crushing strength of 130 MPa or more and an oil-impregnated rate of 12 vol % or more was comprehensively judged as “∘”, and a test piece that did not satisfy at least one of the above-mentioned conditions was comprehensively judged as “x”.

TABLE 2

| | Radial crushing | Oil-impregnated | Comprehensive |
|---|---|---|---|
| | strength [MPa] | rate [vol %] | judgment |
| Example 1 | ◯ | ⊚ | ◯ |
| Example 2 | ◯ | ◯ | ◯ |
| Comparative | Δ | ◯ | X |
| Example 1 | | | |
| Comparative | ⊚ | X | X |
| Example 2 | | | |
| Comparative | ⊚ | X | X |
| Example 3 | | | |
| Comparative | ⊚ | X | X |
| Example 4 | | | |

First, with regard to the radial crushing strength, as shown in Table 2, all the evaluated test pieces (Examples 1 and 2, and Comparative Examples 1 to 4) showed a value at a level of more than 100 MPa. Specifically, Comparative Example 1 showed only a value of less than 130 MPa, whereas Examples 1 and 2 each showed a value of 130 MPa or more.

In addition, with regard to the oil-impregnated rate, Example 1 showed a value of 15 vol % or more, and Example 2 and Comparative Example 1 each showed a value of 12 vol % or more, whereas Comparative Examples 2 to 4 each showed only a value or less than 12 vol %.

In summary of the foregoing, it has been revealed that, according to the green compact using the metal powder (in this embodiment, the pure iron powder) having the shape showing a circularity R at a cumulative frequency of 80% of 0.75 or more, and/or showing a jaggedness C at a cumulative frequency of 80% of less than 2.90, an oil-impregnated rate of 12 vol % or more can be achieved while a radial crushing strength of 130 MPa is secured.

While one embodiment of the present invention has been described above, needless to say, the green compact and the method of producing the same according to the present invention may adopt any modes within the scope of the present invention without being limited to the mode exemplified above.

For example, in the above-mentioned embodiment, the case of using the pure iron powder produced by the water atomizing method has been described as Examples. Needless to say, however, the production method is not limited thereto. That is, as described above, the green, compact, according to the present invention has a feature in shape of the metal powder serving as a material for the green compact, and hence is not limited by its production method. Admittedly, there may be such an aspect that its shape (in terms of circularity R or jaggedness C, the magnitude thereof) may be determined to some degree by the product ion method, but even pure iron powder produced by a product ion method other than that of Examples (e.g., a gas atomizing method) may be used as the metal powder according to the present invention as long as its shape satisfies the criteria according to the present invention (a circularity R of 0.75 or more, or a jaggedness of less than 2.90). Needless to say, the same applies to the case of using metal powder other than pure iron powder.

In addition, in the above-mentioned embodiment, the case of using the pure iron powder as the metal powder serving as the main raw material for the taw material powder has been described. Needless to say, however, iron-based powder other than the pure iron (including alloy powder) may also be used, and metal powder containing two or more kinds of metal powders (e.g., pure iron powder and copper powder) may also be used. In that case, at least one kind of the metal powders only needs to be metal powder serving as the constituent particles of the green compact, and the remaining metal powder may be, for example, metal powder (e.g., tin powder) functioning as a binder between the constituent particles by being melted during the heat treatment (e.g., steam treatment) for forming the oxide film after the compaction-molding. Needless to say, the size of each powder (particle size) may also be any size as long as the compaction-molding can be performed, and the size is not limited to that in the above-mentioned embodiment.

In addition, in the above-mentioned embodiment, the case of using an organic lubricant as raw material powder other than the main raw material has been described. Needless to say, however, a lubricant other than the organic lubricant may also be used. In addition, one kind or two or more kinds of various additives for imparting functions other than a lubricating function in the compaction-molding to the green compact may be blended with the main raw material.

In addition, in the above-mentioned embodiment, the case where the raw material powder having blended thereinto the amide wax-based lubricant is compaction-molded, subjected to the degreasing treatment, and then subjected to the steam treatment has been exemplified. Needless to say, however, when the lubricant remaining in a finished product does not cause a problem in terms of function, the steam treatment may be performed without the degreasing treatment.

In addition, in the above-mentioned embodiment, the case of using the uniaxial pressing as a compaction-molding technique for the green compact has been exemplified. Needless to say, however, other molding techniques may also be adopted. For example, various molding techniques, such as multiaxial pressing with a CNC press or the like, and injection molding (MIM), may be adopted as the molding technique for the green compact.

In addition, the green compact according to the foregoing description is suitably applicable not only to a slide bearing, for example, a cylindrical oil-impregnated bearing (e.g., a perfectly circular fluid bearing or a fluid dynamic bearing capable of rotatably support a shaft through the intermediation of an oil film of a lubricating oil), but also to other kinds of sliding parts utilizing the seeping of a lubricating oil. Needless to say, the green compact according to the present invention may be applied to a machine part other than the sliding parts.

1. A green compact, which is obtained by compaction-molding raw material powder containing metal powder as a main raw material,
the green compact comprising an oxide film formed between particles of the raw material powder forming the green compact, the oxide film binding the particles of the raw material powder to each other,
wherein the metal powder to be used comprises metal powder showing a circularity R at a cumulative frequency of 80% of 0.75 or more,
the circularity R being expressed by Equation 1, where S represents a two-dimensional projected area of the metal powder and L represents a two-dimensional projected circumferential length of the metal powder.
$$R = 4 π \times \frac{S}{{L}^{2}} \qquad Equation 1$$

2. A green compact, which is obtained by compaction-molding raw material powder containing metal powder as a raw material,
the green compact comprising an oxide film formed between particles of the raw material powder forming the green compact, the oxide film binding the particles of the raw material powder to each other,
wherein the metal powder to be used comprises metal powder showing a jaggedness C at a cumulative frequency of 80% of less than 2.90,
the jaggedness C being expressed by Equation 2, where S represents a two-dimensional projected area of the metal powder and L represents a two-dimensional projected circumferential length of the metal powder.
$$C = \frac{1}{4 π} \times \frac{{L}^{2}}{S} \qquad Equation 2$$

3. The green compact according to claim 1, wherein the metal powder to be used comprises metal powder further showing a jaggedness C at a cumulative frequency of 80% of less than 2.90,
the jaggedness C being expressed by Equation 3, where S represents the two-dimensional projected area of the metal powder and L represents the two-dimensional projected circumferential length of the metal powder.
$$C = \frac{1}{4 π} \times \frac{{L}^{2}}{S} \qquad Equation 3$$

4. The green compact according to claim 2, wherein the metal powder to be used comprises metal powder further showing a circularity R at a cumulative frequency of 80% of 0.75 or more,
the circularity R being expressed by Equation 4, where S represents the two-dimensional projected area of the metal powder and L represents the two-dimensional projected circumferential length of the metal powder.
$$R = 4 π \times \frac{S}{{L}^{2}} \qquad Equation 4$$

5. The green compact according to claim 1, wherein the green compact has a green density of 5.0 g/cm³ or more and 7.6 g/cm³ or less.

6. The green compact according to claim 1, wherein the metal powder comprises iron-based powder.

7. The green compact according to claim 1, wherein the oxide film is formed by subjecting a surface of the raw material powder to steam treatment.

8. A slide bearing, which is formed of the green compact of claim 1, the slide bearing comprising a bearing surface configured to slidably support a shaft.

9. The slide bearing according to claim 8, wherein internal pores of the green compact are impregnated with 12 vol % or more of a lubricating oil.

10. A method of producing a green compact obtained by compaction-molding raw material powder containing metal powder as a main raw material, the green compact comprising an oxide film formed between particles of the raw material powder forming the green compact, the oxide film binding the particles of the raw material powder to each other,
the method comprising the steps of:
molding the green compact using, as the metal powder, metal powder showing a circularity R at a cumulative frequency of 80% of 0.75 or more; and
subjecting a surface of the raw material powder in a state of forming the green compact to steam treatment, to thereby form the oxide film between the particles of the raw material powder,
the circularity R being expressed by Equation 5, where S represents a two-dimensional projected area of the metal powder and L represents a two-dimensional projected circumferential length of the metal powder.
$$R = 4 π \times \frac{S}{{L}^{2}} \qquad Equation 5$$

11. A method of producing a green compact obtained by compaction-molding raw material powder containing metal powder as a main raw material, the green compact comprising an oxide film formed between particles of the raw material powder forming the green compact, the oxide film binding the particles of the raw material powder to each other,
the method comprising the steps of:
molding the green compact using, as the metal powder, metal powder showing a jaggedness C at a cumulative frequency of 80% of less than 2.90; and
subjecting a surface of the raw material powder in a state of forming the green compact to steam treatment, to thereby form the oxide film between the particles of the raw material powder,
the jaggedness C being expressed by Equation 6, where S represents a two-dimensional projected area of the metal powder and L represents a two-dimensional projected circumferential length of the metal powder.
$$C = \frac{1}{4 π} \times \frac{{L}^{2}}{S} \qquad Equation 6$$

12. The method of producing a green compact according to claim 10, wherein the steam treatment for the surface of the raw material powder is performed in a temperature range of 400° C. or more and 700° C. or less.
